(19) United States
(12) Patent Application Publication
(10) Pub. No.: US 2009/0253342 A1
(43) Pub. Date: Oct. 8, 2009

(54) Infant activity mattress

(75) Inventors: Shoshana Oren, Herzeliya (IL); Elisha Avraham Tal, D.N. Hare Yehuda (IL); Eitan Shalom Sharif, Gesher Haziv (IL); Eyal Vogel, Tel Aviv (IL)

Correspondence Address: THE NATH LAW GROUP, 112 South West Street, Alexandria, VA, 22314, US

(73) Assignee: Tiny Love LTD, Tel Aviv (IL)

(21) Appl. No.: 11/990,978

(22) PCT Filed: Aug. 30, 2006
(86) PCT No.: PCT/IL06/01005

§ 371 Date: Feb. 26, 2008

Related U.S. Application Data
(60) Provisional application No. 60/712,411, filed on Aug. 31, 2005.

(51) Int. Cl. A63H 33/00; A47D 13/00; B68G 5/00

(52) U.S. Cl. 446/227; 5/655; 5/417

(57) ABSTRACT

An infant activity mattress comprising a collapsible floor mat made of flexible material rimed with a looped stiff though twistable support band, the mat being deformable between an expanded, essentially flat position, and a folded position; said mattress comprising a plurality of coupling sockets distributed adjacent edges of the mat, each for detachably coupling thereto an end of an arch or a stimulating element.

### FIELD OF THE INVENTION

This invention relates to an infant activity mattress (often referred to also as an infant activity/entertainment center) and more particularly to such an activity mattress which is modular and may thus be assembled in many different configurations.

### BACKGROUND OF THE INVENTION

The activities which an infant carries out in the first months of its life plays an important role in the infant's acquisition of basic motor skills and in its ability to recognize differences in the shapes, colors and sizes of various objects, as well as differences between musical tones and other sounds. It is only by experience that the infant learns how to properly manipulate its arms and legs and to understand the nature of what it sees and hears. An infant whose activities in this crucial period are restricted, may suffer from an arrested development which may interfere with his future progress.

In order to stimulate an infant into activities that will advance its development during the earliest period of its life, it is known to provide for this purpose an activity center designed to induce the infant occupying the center to turn around, to raise its head, to move its arm and leg appendages and to engage in other beneficial activities.

The structure of this center is such as to give its baby occupant a sense of security. An important factor controlling an infant's development is security, for an infant is defenseless and should it for any reason feel insecure, it will cry out to call attention to its condition, and not engage in play activity. Thus if an infant is taken out of its crib and placed on the floor of a nursery to play with toys, because it will feel insecure in this unprotected environment, it will then sob rather than play.

A known form of an infant activity center which imparts a sense of security to an infant and functions as a playground is a collapsible center having a square floor mat of soft material on which an infant may comfortably lie, the diagonally-opposed corners of the mat being bridged by intersecting arches which extend between respective pairs of corners to create, as it were, an open-sided gazebo which gives the infant therein a sense of being safely enclosed despite the absence of enclosing walls.

Dangling from the arches of this center are play objects appropriate to the infant's age and state of development. Thus when the infant is less than 2 months old, the dangling object may simply be objects which differ in size, shape and color to develop the baby's ability to visually distinguish these objects from each other. Also wind chimes or mechanical or electronic “sound boxes” may be provided to expose the infant to different tones and melodies. Also there may be provided different light emitting figures and toys for attracting and exciting the infant.

US Design Patent 359,869 to Oren illustrates a well known baby's activity mattress according to the above disclosure.

U.S. Pat. No. 5,928,054 discloses a playcenter for babies including a resilient foam arch, play objects and a pouch into which the resilient foam arch may be folded for transport. The resilient foam arch is supported in a substantially vertical plane. The play objects are suspended from the resilient foam arch.

U.S. Pat. No. 6,702,643 discloses an infant entertainment device and a support assembly for positioning the entertainment device in view of an infant. The support is reconfigurable between an expanded configuration and a collapsed configuration. The entertainment device is responsive to actuation of a motion detector coupled to the entertainment device.

U.S. Pat. No. 7,037,170 discloses a toy accessory includes an arch and a connector attached to each end of the arch. The connector is configured to attach to either of a top rail of a juvenile product and an edge of a play mat. The connector includes an arch connection portion configured to connect to the respective end of the arch and also includes a receiving portion configured to receive either of the top rail of the juvenile product and the edge of the play mat. The connector further may include a play mat connection portion configured to connect to a surface of the play mat.

More so, a baby's development can be advanced by making it possible for the baby to see its own image in a mirror when it engages in various activities, for the baby can then observe how it reacts to stimuli. Thus if a baby is induced by rhythmic sounds to swing its arms and legs in keeping with the rhythm and can see himself doing so, this may encourage the baby to move more vigorously or to modify its movements. A mirror can make a significant difference in an infant's progress during the first six months of his life, for the mirror in combination with activity-stimulating play pieces create a biofeedback network in which the infant sees in the mirror his physical reaction to the stimuli afforded by the objects dangling from the arches, and the image he sees induces the infant to alter his behavior to improve his performance.

US Patent Application 2004/0266312 to Oren et al discloses a mirror assembly mountable on an arch of an infant activity center comprising a foldable floor mat, said arch bridging remote areas thereof. The mat is flexible and the arch is bendable whereby the center can be collapsed to create a pack in which the mat is folded and the arch lies therein. The mirror assembly includes a disc on whose front face is a mirror, the rear face being hinged to one side of a triangular easel web whose other side is hinged to a sleeve fitted on the arch, whereby in an active mode of the assembly, the easel web supports the mirror from the arch, whereas in a collapsed mode, the web is folded against the rear face of the disc which is now sandwiched within the mat.

It is an object of the present invention to provide an infant activity mattress easily foldable/collapsible and wherein assembly and configuration of one or more arches and activity-stimulating play pieces and stimulating elements is modular and simple.

### SUMMARY OF THE INVENTION

According to the present invention there is provided an infant activity mattress assembly comprising a collapsible floor mat made of flexible material rimed with a looped stiff though twistable support band, the mat being deformable between an expanded, essentially flat position, and a folded position; said mattress comprising a plurality of coupling sockets distributed adjacent edges of the mat for detachably coupling an end of an arch and a stimulating element; one or more arches comprising a solid bendable core enveloped by a soft cushioning layer and fitted at each respective end with a coupler element for detachably coupling to any one of the coupling sockets; and one or more stimulating elements comprising a base portion fitted with a coupler element for detachably coupling to any one of the coupling sockets.

The arrangement is such that the arches and stimulating elements may be detachably coupled to the mat at any desired position and at a variety of modular combinations.

The invention calls for an infant activity mattress comprising a foldable/collapsible floor mat made of flexible material rimed with a looped band, the mat being deformable between an expanded, essentially flat position, and a folded position; said mattress comprising a plurality of coupling sockets distributed adjacent edges of the mat for detachably coupling an end of an arch or a stimulating element.

Hereinafter in the specification and claims the term stimulating element refers to any article used for stimulating a child, e.g. figures/figurines, soft elements, music boxes, mirrors, etc. Such stimulating elements may be either dangling from an arch of the activity mattress or articulated to the floor mat (the activity mattress) and projecting substantially vertically therefrom, or as an independent article (either while occupying the activity mattress or away therefrom as a ‘take along’ toy).

The mat, at its compacted, folded position has at least two overlapping layers. At the open/extended position, the mat is substantially flat and the material is substantially tensioned/stretched over the band. At one configuration of the folded position edges of the mat are substantially parallel and in proximity to one another.

The arrangement is such that a plurality of arches and stimulating elements are provided, whereby one or more arches and one or more stimulating elements are detachably articulable to the mat at any desired configuration. The mat retains its stretched form also when the arches and one or more stimulating elements are attached thereto, regardless the coupling position of the one or more arches and the one or more stimulating elements.

According to an embodiment of the invention, the coupling socket is formed in a rigid support member integrated over the support band. At least some of the coupling sockets are formed with a flat floor portion inwardly (radially) extending therefrom, for preventing buckling of the mat also when an arch or a stimulating element is articulated thereto.

According to a particular arrangement of the invention, the support band has a rectangular cross-section and it is made of steel. However plastic bands and of different cross-sections are possible too. The support band fixedly extends through the support member. This may be by molding the support member over the support band or for example, by a groove through which the support band extends, at tight fit, or by suitable fastening means.

Typically, the floor mat envelopes the band and the support members, apart for the respective coupling socket projecting through a surface of the mat. The mat, according to one of the embodiments, may be useful at both sides thereof, whereby each face thereof is fitted with coupling sockets. For example, one face of the mat may comprise a colored pattern whilst the other face thereof may be formed with black & white patterns suited for the very young ones. Most likely, the mat has a generally round-shaped contour e.g. oval, circular, egg-shaped, etc.

The arrangement is such that owing to the support band the mat retains its expanded shape regardless if one or more arches are engaged within the coupling sockets and regardless the configuration of engaging the arches to the mat. Furthermore the mat spontaneously deforms from its collapsed position to its fully expanded position, once allowed to expand.

Typically, the coupling sockets of the mat are female components of any type of a male/female coupler so as to minimize projections from the mat's surface.

A coupler socket assembly, as described herein the specification and claims may be of any type, and different types of couplers may be provided for detachably coupling different elements. Setting as examples only, the couplers may selected from a group comprising bayonet couplings, snap couplings, pressure fits and screw couplings.

According to another aspect of the invention there is provided a stimulating element for an infant activity mattress according to the present invention, the stimulating element comprising a base portion fitted with a coupler element for detachably coupling to any one of a plurality of coupling sockets distributed adjacent edges of a mat of the infant activity mattress. However, some or all of the stimulating elements may be also fitted for dangling from an arch attached to the mat and may thus be fitted with an integral or detachable hanger or a loop for receiving a hanger.

According to a particular design the base portion of the stimulating element supports a rigid though pliable core for retaining the stimulating element at a substantially upright position over the mat. However, the stimulating element may be bent over. Where a coiled spring is provided, it is advantageous that it be covered by an enveloping layer.

According to still an other aspect of the invention there is provided an arch for an infant activity mattress comprising a solid bendable core (e.g. made of steal, plastic material, reinforced fiber material, etc.) surrounded by a flexible layer and fitted at each respective end with a coupler element for detachably coupling to any one of a plurality of coupling sockets distributed adjacent edges of a mat of the infant activity mattress. The arch may be enveloped within a patterned sheath and may be provided with lops or hooks or other arrangements for attaching thereto different stimulating elements at a fixed or detachable fashion.

Typically, a coupler element of a stimulating element and of an arch is a male component of any type of male/female coupler, to thereby project into the coupling sockets formed in the mat. Furthermore, the stimulating element may be articulated to the coupling sockets via a springy element for retaining the stimulating element at a substantially upright though deformable position.

However, as stated herein above, the coupling mechanism may be of any design and each of the coupler element and coupling socket may be of corresponding design (male/female). Still, the stimulating element may be coupled, using the coupler element, at other locations, such as a suitable coupling socket of a stroller, etc.

The mat according to one of its designs may be folded into its collapsed position also when the arches and stimulating elements are attached thereto.

### BRIEF DESCRIPTION OF THE DRAWINGS

In order to understand the invention and to see how it may be carried out in practice, some embodiments will now be described, by way of non-limiting examples only, with reference to the accompanying drawings, in which:

FIG. 1 is an isometric view illustrating the infant activity mattress assembled in accordance with a first configuration thereof;

FIG. 2 illustrates the infant activity mattress assembled in accordance with another configuration thereof;

FIG. 3A is an enlarged isometric view of a bayonet-type coupling assembly comprising a coupling socket and a coupler element detached from one another;

FIG. 3B is an isometric section through the coupling assembly of FIG. 3A, engaged with one another;

FIG. 3C is a sectioned isometric view of a coupling assembly comprising a socket and a coupler element, according to a modification thereof, detached from one another;

FIG. 3D is a sectioned isometric view through the coupling assembly of FIG. 3C, at an attached position;

FIG. 3E is a sectioned view of an end portion if a coupler element according to a different embodiment, fitted with a springy element;

FIGS. 4A and 4B are a view of an arch and a longitudinal section therethrough, respectively;

FIG. 4C is an illustration of a modification of an arch;

FIG. 5A illustrates a stimulating element articulated to the mat at an essentially upright position;

FIG. 5B illustrates flexibility of the stimulating element seen in FIG. 5A; and

FIGS. 6A-6C are consecutive steps illustrating how the mat of the activity mattress is deformed from its expanded position to its folded, collapsed position.

### DETAILED DESCRIPTION OF THE INVENTION

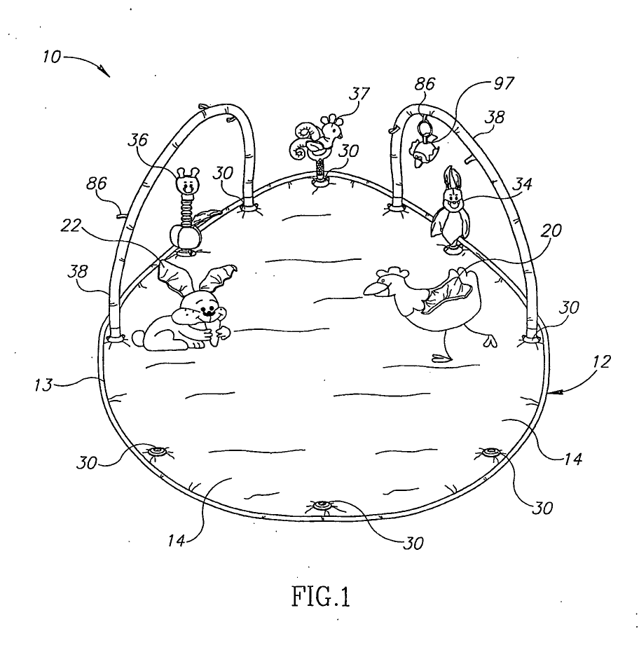

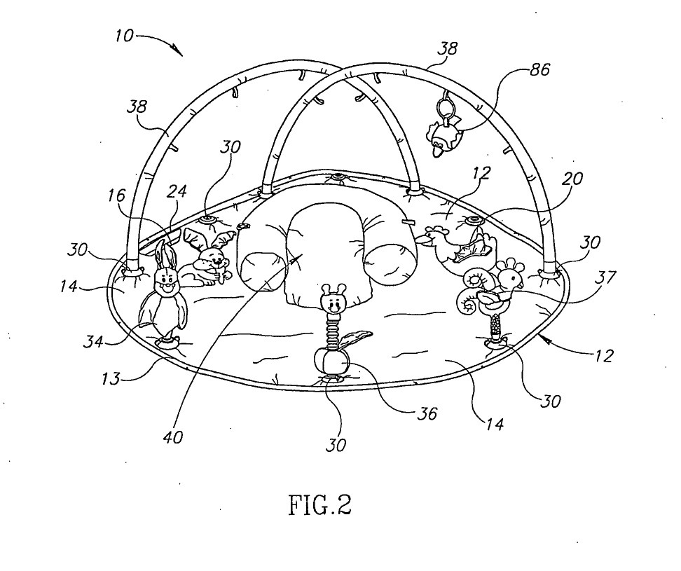

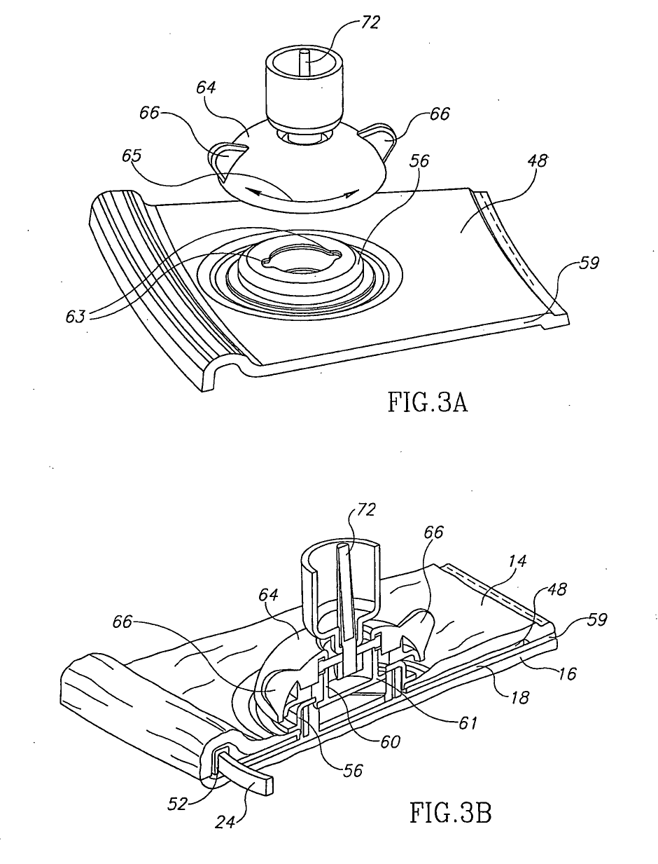

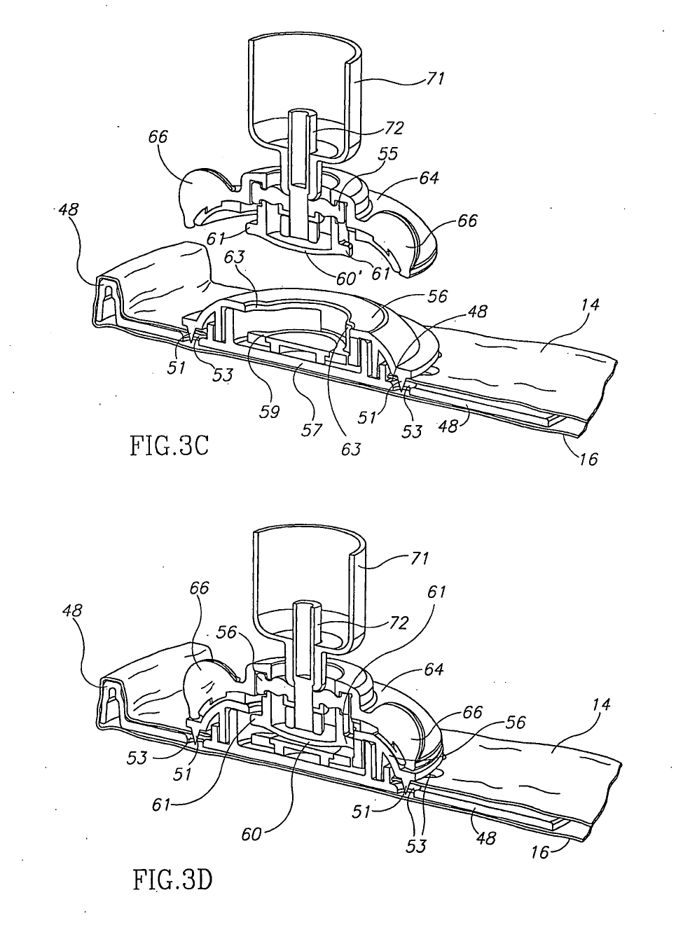

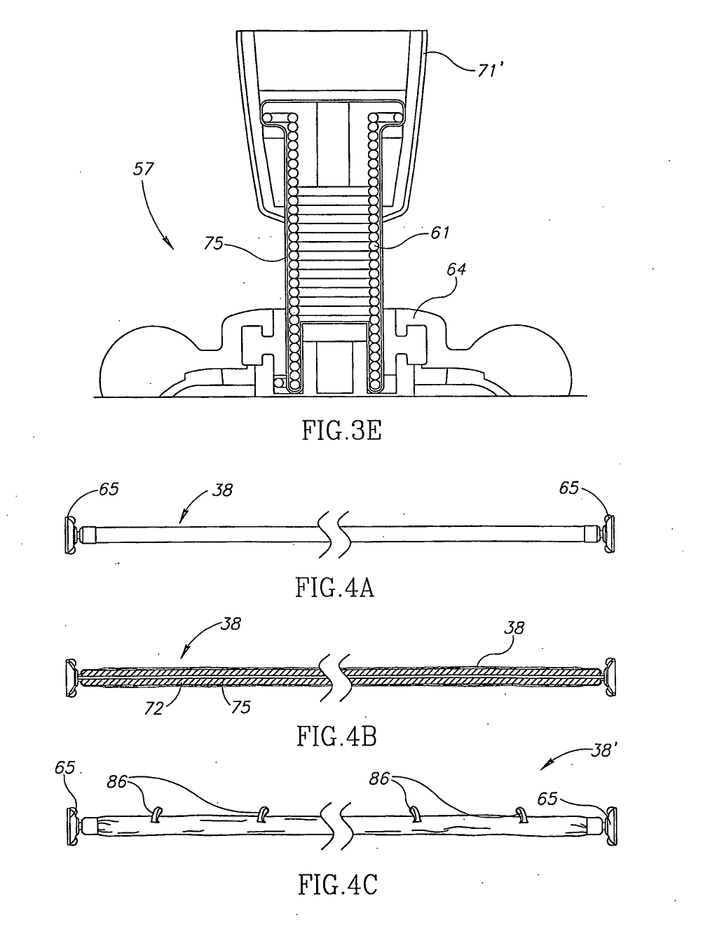

Attention is first directed to FIGS. 1 and 2 illustrating an infant activity mattress in accordance with the present invention generally designated 10 comprising a collapsible floor mat 12 made of an upper layer of fabric 14 and a lower layer of fabric 16 (FIGS. 2, 3C and 3D) with an intermediate cushioning layer (not seen) made for example of sponge, foamed material, etc.. In the present example, one surface 14 is printed or embroidered with some childish drawings or patterns with some features stitched thereto, e.g. hen wings 20, rabbit ears 22, etc. It may be appreciated, however, that an opposite face of the floor mat may be imparted with other illustrations e.g. black/white patterns, which are considered to be stimulative for the very young ones. Still, the mat may be manufactured of liquid impermeable and washable materials.

The mat 12 is rimmed by a looped stiff though twistable support band 24 (FIG. 3B), for example, made of a steel wire, plastic material, etc., wherein said support band 24 is retained within a channel 13 stitched along the edge of the floor mat 12.

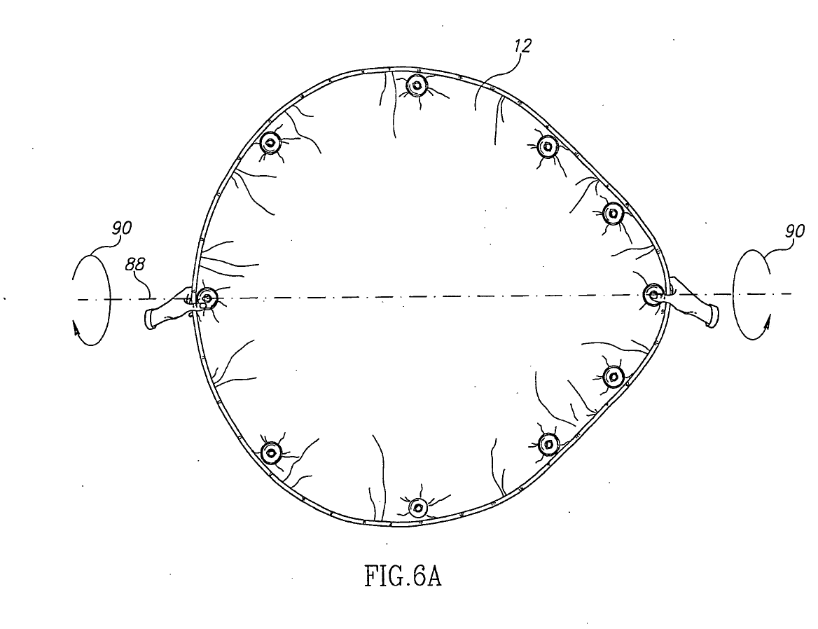

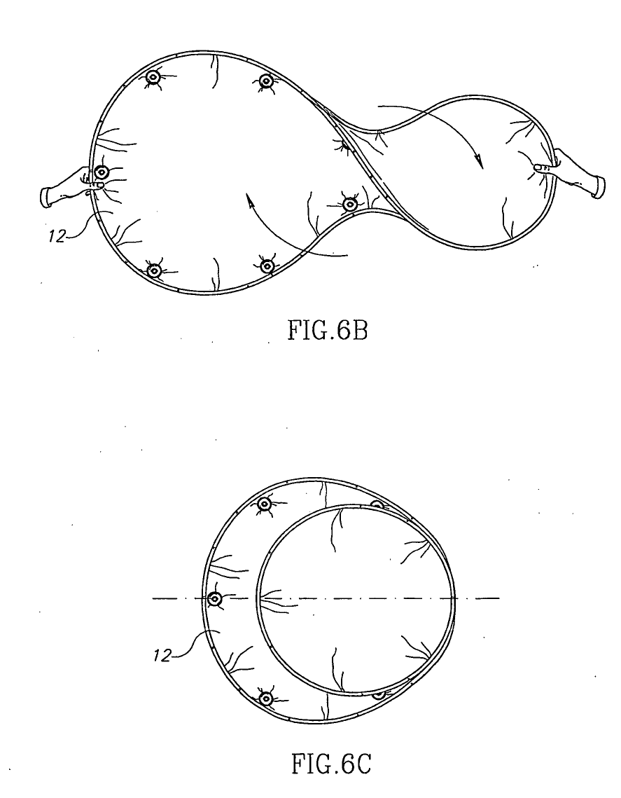

The arrangement is such that the mat is deformable between an expanded, essentially flat position as in FIGS. 1, 2 and 6A, and a collapsed/folded position as in FIG. 6C, and wherein the mattress will spontaneously displace into its extended position, once it is allowed to open. At the flat position the mat is tensioned over the band. The activity mattress may be provided with suitable bands (e.g. elastic bands, Velcro™ fasteners, etc. for retaining the mat at its collapsed state and preventing it from spontaneously displacing into its expanded position. Alternatively, the activity mattress may be supplied with a suitable carrying bag for receiving the mat and the accessories thereof.

Formed along the periphery of the floor mat 12 there are provided a plurality of coupling sockets 30, forming part of a coupling assembly, the nature of which will become apparent hereinafter.

In the embodiments of FIGS. 1 and 2, some of the coupling sockets 30 are occupied by stimulating elements such as ‘rabbit’ 34, ‘worm’ 36, ‘chick’ 37 and other coupling sockets are occupied by respective ends of arches 38.

In FIG. 1 the arches 38 do not intersect one another whilst in FIG. 2 the arches 38 cross one another, however with the mat 12 retaining its substantially flat position. Furthermore, in FIG. 2 there is provided a support cushion 40 for supporting an infant at a desired position. This support cushion may be detachable-attachable to the floor mat or merely lay there.

It should be pointed out that the stimulating elements 34, 36 and 37 and the arches 38 are detachably attached to the floor mat 12 and extend substantially upright therefrom whilst, as mentioned hereinabove, the floor mat 12 remains substantially un-deformed, i.e. flat. This is obtained owing to the detachable coupling arrangement as will be disclosed hereinafter with further reference to FIGS. 3A and 3B and the stiff support band 24. The arrangement is such that the one or more 38 arches and the one or more stimulating elements 34 may be detachably coupled to the mat 12 at any desired position and at a variety of modular combinations.

In FIGS. 3A and 3B there is illustrated, by way of example only, a coupling assembly for coupling an arch or a stimulating element to the floor mat, wherein for sake of clarity the cushioning layer has been removed. As can be seen in FIG. 3B, intermediate the fabric layers 14 and 16 there is provided a support member 48 made of rigid material, e.g. plastic, formed at its peripheral zone with support-band receptacle in the form of an inverted U-like section 52 or a channel, snugly receiving the rectangular cross-sectioned support band 24 in a fixed relations such that the support member 48 prevents buckling of the support band 24 and of the floor mat 12.

Formed in the support member 48 there is a coupling socket 56 in the form of a receptacle of a bayonet-type coupler wherein said coupling socket 56 is the ‘female’ portion and is adapted for detachably locking thereto a corresponding ‘male’ bayonet component 60 (FIG. 3B) of an arch or a stimulating element. The arrangement is such that articulating between a coupling socket of the floor mat and the arch of the stimulating element is fast and easy, providing adequate locking to thereby prevent unintentional detaching by handling of the infant. Furthermore, the female component hardly projects from the surface of the mat, if at all.

It is noticed that the support member 48 is formed with an essentially flat floor surface 59 extending radially inwardly from the peripheral band 24 articulated thereto. The purpose of the flat portion is to prevent buckling of the floor 12 mat under the self weight of the stimulating elements or the force applied by the arches 38 articulated thereto, regardless of the configuration at which they are arranged.

Whilst in the embodiment of FIGS. 3A and 3B the coupling assembly is illustrated as a bayonet-type coupling, it should be appreciated that many other types of couplings are possible, setting as examples, screw-coupling, snap-fitting, magnetic coupling, press-fit couplings, etc. However, a common feature of all couplings is that the coupling socket formed on the floor mat 12 projects to a minimal extent, if at all, and typically, said coupling socket formed on the floor mat would be a female component of such a coupling assembly, so as to minimize any injury risk.

As can further be seen in FIGS. 3A and 3B, the locking member 60 of the male-bayonet component is concealed by a manipulating cap 64 formed with a pair of manipulating ears 66 to facilitate tight locking of the arch or stimulating element to the floor mat, whereby engagement is facilitated merely by placing the locking member 60 over a respective coupling socket 38 so that locks 61 fit into apertures 63 and rotating it in direction of arrow 65 (FIG. 3A), and where disengagement is facilitated by rotation of the locking member 60 in an opposite direction and retracting it.

As discussed hereinbefore, the stimulating elements as well as the arches project substantially upright from the floor mat owing to a core rod 72 extending through the stimulating element or the arch, said core rod being rigid though pliable so as to allow bending the arches 38 (FIGS. 1 and 2; and also for their storage while not in use) and to allow deformation of the stimulating element such that the infant can play with it on the one hand and, in case of falling or rolling over it, there is no actual risk of injury.

Turning now also to FIGS. 3C and 3D there is illustrated a slightly different embodiment of a coupling arrangement in accordance with the present invention, wherein like elements are designated same reference numbers as in FIGS. 3A and 3B. As seen in FIG. 3C, the male-bayonet component 60 has two laterally extending locks 61 for projecting into corresponding apertures 63 (best seen in FIG. 3A) formed in the coupling socket 56 of support member 48: Rotation of the male-bayonet component 60′ in either direction entails locking engagement of the male and female bayonet components.

As can further be seen, the upper layer 14 of the mat, is secured to the flat support member 48 by a plurality of prongs 51 extending from the cover 56 of the coupling socket and projecting through the fabric 14 into corresponding apertures 53 formed in the support member 48 whilst axial engagement pressure is obtained by a resilient member 55 which at the assembled position (FIG. 3D) ensures tight coupling of the male and female bayonet coupling elements. An additional secure fastener may be provided, e.g. a rivet (not seen) for securing the top 59 member and the bottom member 57, of the socket. A cup-like receptacle 71 is provided for fixedly attaching thereto over stem portion 72, a respective end of an arch or a stimulating element, e.g. by adhering, various fasteners and the like.

Also, in order to increase stability, the rim of the mat is stitched so as to form the channel 13 accommodating the band 24, where said stitch extends also through a peripheral portion of the support member 48.

In FIG. 3E there is illustrated a modification of a coupling assembly generally designated 57 which is different from the previous embodiments in that the stimulating element (not shown) is articulated to a receptacle unit 71′ supported by a springy element 61 (a coiled spring in the present embodiment, though it may well be any form, of elastic material) articulated in turn to the manipulating cap 64 of the male bayonet component, the latter being similar to that disclosed hereinbefore. The springy element 61 is suitable for retaining the stimulating element at a substantially upright position though is sufficiently flexible such that a baby can manipulate the stimulating element and further, in case of the baby falling or rolling over said element, the risk of injury is minimized, if at all. The elastic member is enveloped by a sheath 75 for an eye-pleasing effect and to avoid pinching between the coils of the spring 61.

FIG. 4A illustrates an arch 38 in accordance with the present invention the length being sufficient for articulating to the mat 12 at various configurations e.g. as illustrated in FIG. 1 or in FIG. 2. A typical length of such an arch may be, for example only, in the range of about 1 to 1½ meters and each end thereof is fitted with an end coupler 65 (male type) in accordance with the present invention, e.g. a coupler as disclosed in any of FIGS. 3.

As can further be seen in the section of FIG. 4B, the arch 38 comprises a core rod 72 being a rigid though flexible material, e.g. steel, fiberglass, plastic material, etc. which may be bent as illustrated in FIGS. 1 and 2, and wherein said core rod 72 is enveloped with a cushioning layer 75, e.g. sponge or foamed material typically received within a patterned fabric envelope 81.

According to an embodiment of the invention illustrated in FIG. 4C, the arch 38′ is enveloped by a colorful sheath fitted with a plurality of eye-rings, loops, hooks or different hangers, collectively designated 86. As noticed in FIGS. 1 and 2 at least some of the stimulating elements, e.g. bird 95 suspends in a dangling manner from the arches 38 owing to loops 86 formed on the arches.

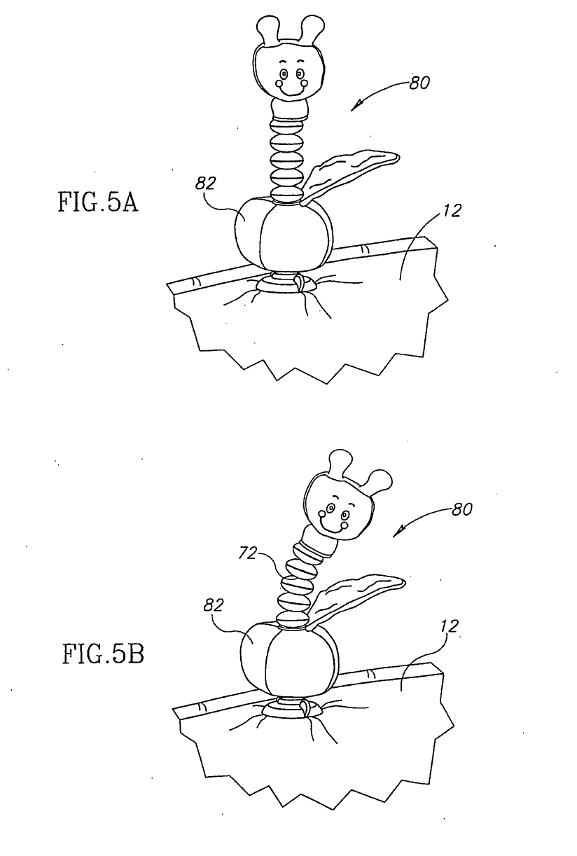

In FIG. 5A there is illustrated a simulating element figure in the form of a smiling worm 80 peaking from a sponged apple 82, where in FIG. 5A the worm extends substantially upright from the floor mat 12 and in FIG. 5B the worm is deformed over the core member 72.

For collapsing the floor mat, the arches 38 and the stimulating elements 34, 36, etc. are detached from the floor mat 12 which is then held at two opposite remote ends substantially along its longitudinal axis 88 and is then twisted in opposite directions as illustrated by arrows 90 into the position of FIG. 6B. Then, the floor mat 12 is further twisted and collapsed over itself in an overlapping manner into the position of FIG. 6C with two or three overlapping layers with the looped band formed in a corresponding overlapping manner. However, as mentioned above, the mat may be collapsed also when the one or more stimulating elements and one or more arches are articulated thereto.

Retaining the floor mat 12 this position may be for example by introducing it into an appropriate carrying bag, by a suitable hook and pile (Velcro™) fastener, snap-type fasteners, etc., or the folded mat may be retained in an appropriate carrying bag. However, releasing the folded/collapsed floor mat will entail its spontaneous deformation into its expanded/open position as in FIG. 6A, this owing to the springy nature of the looped band.

Advantageously, the mat and the one or more arches and stimulating elements are a wash-resistant.

Whilst not illustrated, the mat may be fitted with attachment means for attaching thereto a cushioned baby's support mattress (40 in FIG. 2). Such attachment means may be, for example, Velcro™ fasteners (hook and pile fastener), buttons, snaps, etc.

Whilst some embodiments have been described and illustrated with reference to some drawings, the artisan will appreciate that many variations are possible which do not depart from the general scope of the invention, mutatis, mutandis.

1. An infant activity mattress comprising a collapsible floor mat made of flexible material rimed with a looped stiff though twistable support band, the mat being deformable between an expanded, essentially flat position, and a folded position; said mattress comprising a plurality of coupling sockets distributed adjacent edges of the mat, each for detachably coupling thereto an end of an arch or a stimulating element.

2. An infant activity mattress according to claim 1, wherein the coupling socket is formed in a rigid support member integrated with the support band and extending inwardly therefrom; said support member comprises a substantially flat floor portion.

3. An infant activity mattress according to claim 1, wherein the band has a rectangular cross-section.

4. An infant activity mattress according to claim 2, wherein the support band fixedly extends through the support members.

5. An infant activity mattress according to claim 1, wherein the floor mat envelopes the support member, apart for the respective coupling socket projecting through a surface of the mat.

6. An infant activity mattress according to claim 1, wherein the mat is useful at both sides thereof, whereby each face thereof is fitted with coupling sockets.

7. An infant activity mattress according to claim 1, wherein the mat retains its expanded shape regardless if arches are engaged within the coupling sockets and regardless configuration of engaging the arches to the mat.

8. An infant activity mattress according to claim 1, wherein on or more arches and one or more stimulating elements are detachably articulable to the mat to any desired configuration.

9. An infant activity mattress according to claim 1, wherein the mat is spontaneously deformable from its collapsed position to its fully expanded position.

10. An infant activity mattress according to claim 1, wherein the coupling socket is a female component of any type of male/female coupler.

11. An infant activity mattress according to claim 1, wherein the mat has a generally round-shaped contour.

12. An infant activity mattress according to claim 1, wherein the stimulating element is articulated to the coupling sockets via a springy element for retaining the stimulating element at a substantially upright though deformable position.

13. An infant activity mattress according to claim 1, wherein at least some of the coupling sockets are formed with a flat piece inwardly extending therefrom.

14. A stimulating element for an infant activity mattress comprising a base portion fitted with a coupler element for detachably coupling to one of a plurality of coupling sockets distributed adjacent edges of a mat of the infant activity mattress.

15. A stimulating element according to claim 14, wherein the base portion supports a rigid though pliable core for retaining the stimulating element at a substantially upright position over the mat.

16. A stimulating element according to claim 14, wherein the coupler element is a male component of any type of male/female coupler.

17. A stimulating element according to claim 14, wherein the stimulating element is articulated to the base portion via a springy element for retaining the stimulating element at a substantially upright though deformable position.

18. An arch for an infant activity mattress comprising a solid bendable core enveloped by a soft cushioning layer and fitted at each respective end with a coupler element for detachably coupling to any one of a plurality of coupling sockets distributed adjacent edges of a mat of the infant activity mattress.

19. An arch according to claim 18, wherein the coupler is a male component of any type of male/female coupler element.

20. An arch according to claim 18, provided with one or more locations for detachably articulating thereto a stimulating element.

21. A mat for an infant activity mattress, said mat being made of flexible material rimed with a looped stiff though twistable support band, the mat being deformable between an expanded, essentially flat position, and a folded position; said mat comprising a plurality of coupling sockets distributed adjacent edges of the mat for detachably coupling an end of an arch and a stimulating element.

22. An infant activity mattress assembly comprising collapsible floor mat made of flexible material rimed with a looped stiff though twistable support band, the mat being deformable between an expanded, essentially flat position, and a folded position; said mattress comprising a plurality of coupling sockets distributed adjacent edges of the mat for detachably coupling an end of an arch and a stimulating element; one or more arches comprising a solid bendable core enveloped by a soft cushioning layer and fitted at each respective end with a coupler element for detachably coupling to any one of the coupling sockets; and one or more stimulating elements comprising a base portion fitted with a coupler element for detachably coupling to any one of the coupling sockets.
